(19) United States
(12) Patent Application Publication
(10) Pub. No.: US 2026/0158440 A1
(43) Pub. Date: Jun. 11, 2026

(54) METHOD AND APPARATUS FOR DRYING AND PURIFYING A FLUID CONTAINING CARBON DIOXIDE AND WATER

(71) Applicant: L'Air Liquide, Société Anonyme pour I'Etude et I'Exploitaion des Procédés Georges Claude, Paris (FR)

(72) Inventors: Mathieu LECLERC, Paris (FR); Cyprien Poucin, Charenton-le-Pont (FR)

(21) Appl. No.: 19/394,508

(22) Filed: Nov. 19, 2025

(30) Foreign Application Priority Data
Dec. 5, 2024 (FR) FR2413520

(51) Int. Cl. B01D 53/26; B01D 53/04; B01D 53/047; B01D 53/22

(52) U.S. Cl. CPC B01D 53/265; B01D 53/0438; B01D 53/047; B01D 53/229; B01D 53/261; B01D 2256/22; B01D 2257/80

(57) ABSTRACT

In a method for drying and purifying a fluid (F) containing CO₂ and water, fluid is cooled against water (1), the cooling water heating up, condensed water (3, BD) is separated to obtain a partially dried fluid (F_{d}), partially dried fluid is dried to obtain a dried fluid (F_{dd}), dried fluid is heated up against water which cools to obtain water (5) and a dried fluid (F_{ddd}) at a seventh temperature T7, water is cooled by heat exchange with a cold-energy source (F1) generating water (1), and generated water is used to cool the fluid.

### CROSS REFERENCE TO RELATED APPLICATIONS

This application claims the benefit of priority under 35 U.S.C. § 119 (a) and (b) to French Patent Application No. FR2413520, filed Dec. 5, 2024, the entire contents of which are incorporated herein by reference.

### BACKGROUND

The present invention relates to a method and to an apparatus for drying and purifying a fluid containing carbon dioxide and water.

Units for capturing and purifying CO₂ from a relatively dilute source (10 to 50 mol % CO₂), operating for example by partial condensation and/or distillation and/or by solidification, require a CO₂ pre-concentration step in order to make the main purification step more efficient (e.g. partial condensation of CO₂). This pre-concentration step is most often carried out via CO₂ PSA or membranes. When the CO₂ source is wet and intended for cryogenics, drying is required, typically inserted prior to the pre-concentration step. The dryer is then relatively large because it treats the entire non-pre-concentrated source. Pre-cooling using cold water makes it possible to condense as much water as possible and reduces the size of the dryer. The invention relates to the optimization of this cooling and drying step.

It is known from FR2884307 to expand the remainder from the pre-concentration step to produce cold and to cool water by direct contact with the expanded remainder.

### SUMMARY

It is known practice to generate cooled water by bringing water into contact with the remainder from the pre-concentration step after expansion. This remainder is depleted in CO₂ and enriched in another component of the fluid to be separated, for example nitrogen.

Another cold-energy source could replace the expanded remainder.

The invention provides for pumping the water cooled by the cold-energy source and using it to cool the fluid to be separated containing between 10 and 50 mol % CO₂ and water. This heat exchange with the fluid to be separated can take place in a heat exchanger or directly in a cooling tower. The water used to cool the fluid heats up and is optionally expanded. Water in the fluid to be separated condenses after cooling and is removed in the form of condensate. The fluid still contains water and is sent to dry in a dryer, for example by temperature swing adsorption.

The cooling capacity of the fluid to be separated is equal to the water cooling capacity of the cold-energy source, it being possible for said cold-energy source to be for example the remainder from the pre-concentration step. If the temperature of the fluid to be separated before cooling with the water cooled by the cold-energy source is too high, it will not be possible for the temperature after cooling with fresh water to be as low as expected. In the case where the cold-energy source is the expanded remainder, if the flow rate of remainder from the pre-concentration step after expansion is relatively too low, it will not be possible for the temperature after cooling with cooled water to be as low as expected. This can happen when the fluid contains too little of the other component.

In that case, less water contained in the fluid to be separated will be condensed, leading to an enlargement of the subsequent dryer.

In addition, since the cooling capacity is limited, the flow rate of cooled water will also be limited. This will imply significant heating thereof up against the fluid to be separated. Thus, this exchange will be constrained on the cold side (where it is sought to cool as much as possible) and on the hot side (since the flow rate is low, the cooled water will heat up to a temperature close to the wet source). Consequently, the size of the means of exchange between the fluid to be separated and the water cooled by the cold-energy source will be larger, thereby implying a large exchange surface for an indirect heat exchanger or a higher exchange zone for a direct-contact tower.

The fluid dried in the dryer can be intended for a pre-concentration step that is not necessarily optimized for relatively cold temperatures. This is in particular true for a pressure swing adsorption (PSA) unit. Thus, in the case of cooling before the dryer, the pre-concentration step is carried out at relatively low temperatures and the downstream separation unit is therefore less efficient and/or larger.

Finally, in the same way, if the pre-concentration step is carried out at relatively low temperature, its remainder will most often be at low temperature as well. Since it is expanded most often in a turbine (generating mechanical power) before it is used for fresh water generation, its relative low temperature induces lower energy recovery or requires additional heat consumption before expansion in order to compensate for this effect. According to one subject of the invention, what is provided is a method for drying and purifying a fluid at a first temperature T1 containing between 10 and 50 mol % of carbon dioxide and also at least one impurity lighter than carbon dioxide chosen from the list: oxygen, nitrogen, argon, carbon monoxide, methane, helium and hydrogen, and also water, comprising the following steps:
a) cooling the fluid at the first temperature T1 to a second temperature T2 against water at a third temperature T3 lower than the first temperature T1 and partially condensing the water contained in the fluid, the cooling water heating up to a fourth temperature T4,
b) separating the condensed water to obtain a partially dried fluid at the second temperature T2,
c) drying the partially dried fluid at the second temperature T2 by passing through an adsorbent to obtain a dried fluid at a fifth temperature T5,
d) heating up the dried fluid at the fifth temperature T5 against water which cools to obtain water at a sixth temperature T6 and a dried fluid at a seventh temperature T7,
e) cooling the water at the sixth temperature T6 by heat exchange with a cold-energy source at an eighth temperature T8 colder than the sixth temperature T6, generating water preferably at the third temperature T3, and
f) using the water generated preferably at the third temperature T3 during step e) to cool the fluid at the first temperature T1 during step a).

According to other optional aspects:
the dried fluid at the seventh temperature T7 is separated into a first fraction at a ninth temperature T9 which is more concentrated in CO₂ than the dried fluid at the seventh temperature T7, and a second fraction at a tenth temperature T10 which is less concentrated in CO₂ than the dried fluid at the seventh temperature T7,
the second fraction at the tenth temperature T10 is expanded, optionally after heating, generating a second fraction at the eighth temperature T8 used as a cold-energy source in step e),
the cooling in step e) is achieved by direct-contact heat exchange between the water at the sixth temperature T6 and the cold-energy source,
the cooling in step e) is achieved by indirect-contact heat exchange between the water at the sixth temperature T6 and the cold-energy source,
the cooling in step a) is achieved by direct-contact heat exchange between the fluid at the first temperature T1 and the water at the third temperature T3,
the cooling in step a) is achieved by indirect-contact heat exchange between the fluid at the first temperature T1 and the water at the third temperature T3, for example a shell and tube exchanger,
the separation of the dried fluid at the seventh temperature T7 is carried out by a pressure swing adsorption system,
the separation of the dried fluid at the seventh temperature T7 is carried out by a membrane system,
the first fraction at the ninth temperature T9 which is more concentrated in CO₂ than the dried fluid at a seventh temperature T7 is compressed and then purified by partial condensation and/or distillation and/or solidification in order to produce a third fraction which is more concentrated in CO₂ than the first fraction,
the water that cools in step d) comprises at least part of the water that heats up in step a),
the water that cools in step d) comprises no part of the water that heats up in step a).

According to another subject of the invention, what is provided is an apparatus for drying and purifying a fluid at a first temperature T1 containing between 10 and 50 mol % of carbon dioxide and also at least one impurity lighter than carbon dioxide chosen from the list: oxygen, nitrogen, argon, carbon monoxide, methane, helium and hydrogen, and also water, comprising:
means for cooling the fluid at the first temperature T1 to a second temperature T2 against water at a third temperature T3 lower than the first temperature T1 allowing partial condensation of the water contained in the fluid, the cooling water heating up to a fourth temperature T4,
means for separating the condensed water to obtain a partially dried fluid at the second temperature T2,
a dryer for drying partially dried fluid at the second temperature T2 by passage comprising an adsorbent and means for sending the partially dried fluid circulating through the adsorbent to obtain a dried fluid at a fifth temperature T5,
means for heating up the dried fluid at the fifth temperature T5 against water which cools to obtain water at a sixth temperature T6 and a dried fluid at a seventh temperature T7,
means for cooling the water at the sixth temperature T6 by heat exchange with a cold-energy source at an eighth temperature T8 colder than the sixth temperature T6, generating water preferably at the third temperature T3, and
means for sending the water generated preferably at the third temperature T3 to the means for cooling the water at the sixth temperature for cooling the fluid at the first temperature T1 in the fluid cooling means, as cooling water.

According to other optional features, the apparatus comprises:
a first separation apparatus for separating the dried fluid at the seventh temperature T7 into a first fraction at a ninth temperature T9 which is more concentrated in CO₂ than the dried fluid at the seventh temperature T7, and a second fraction at a tenth temperature T10 which is less concentrated in CO₂ than the dried fluid at the seventh temperature T7,
an expansion turbine and means for sending at least part of the second fraction to the expansion turbine,
the means for cooling water are means for direct-contact heat exchange between the water at the sixth temperature T6 and the cold-energy source,
the means for cooling water are means for indirect-contact heat exchange between the water at the sixth temperature T6 and the cold-energy source,
the means for cooling the fluid to be dried are means for direct or indirect-contact heat exchange, for example in a shell and tube exchanger,
the separation apparatus is a pressure swing adsorption system,
the separation apparatus is a membrane system,
a second separation apparatus for separation by partial condensation and/or distillation and/or solidification, connected to the first separation apparatus for separating the first fraction to produce a third fraction which is more concentrated in CO₂ than the first fraction,
means for sending water that cools against the fluid dried in the dryer comprises at least part of the water that heats up against the fluid to be dried.

The invention consists in recovering the cold energy at the outlet of the dryer by transferring it to the cooled water before the latter is cooled by the cold-energy source which may for example be the remainder from the pre-concentration step. To do this, the cooled water exchanges heat in an indirect-contact exchanger (for example, a plate-fin exchanger or a shell and tube exchanger) with the fluid to be separated that has been dried, at the outlet of the dryer.

This configuration makes it possible to upgrade the cold energy that was in that case discharged mainly into the cold-energy source, for example the remainder from the pre-concentration step during the heating thereof before expansion. Thus, the flow rate of circulating cooled water can be increased for the same cold temperature obtained after cooling by the cold-energy source, or, for the same flow rate, a colder temperature can be reached.

This makes it possible to even further cool the wet source and therefore to reduce the size of the dryer.

In particular, if a cooling tower with direct-contact between the water and the wet source is used, the increase in the flow rate of fresh water makes it possible to reach temperatures at the inlet of the dryer with fewer constraints in terms of approach, making it possible to take maximum advantage of the invention.

The higher water flow rate also makes it possible to limit the temperature of the water after it has been heated up against the fluid to be separated which cools. The approach between the fluid to be separated and the water cooled by the cold-energy source after exchange is then increased. This makes it possible to increase the compactness of the exchange means, or even to relax constraints that would not be acceptable with respect to some technologies. An approach that is too small makes the industrial use of a shell and tube exchanger impossible. Thus, the exchange surface of an indirect-contact exchanger or the height of a direct-contact cooling tower is reduced.

Finally, the temperature at the inlet of the pre-concentration step, when present, is then increased, which can make it more efficient, in particular in the case of a pressure swing adsorption (PSA) unit. The CO₂-depleted remainder from the PSA is also available at a higher temperature, minimizing its heat demand before its expansion.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a method according to the invention,

FIG. 2 shows a method according to the invention,

FIG. 3 shows a method according to the invention.

### DETAILED DESCRIPTION OF THE PREFERRED EMBODIMENTS

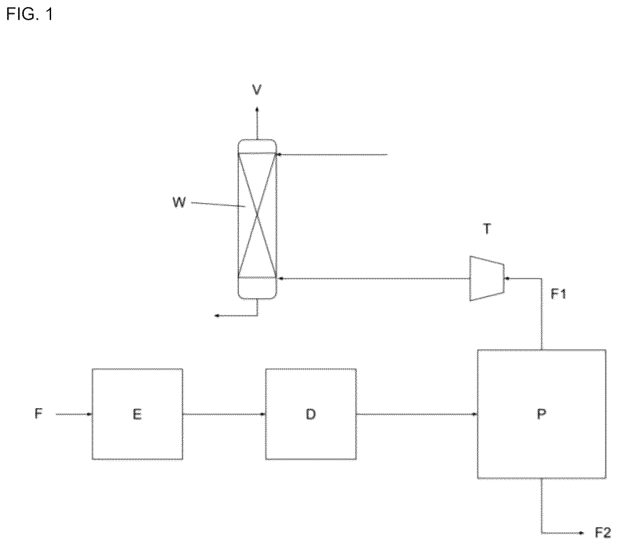

FIG. 1 illustrates a method according to the prior art in which a fluid at a first temperature T1 containing carbon dioxide and also at least one impurity lighter than carbon dioxide chosen from the list: oxygen, nitrogen, argon, carbon monoxide, methane, helium and hydrogen, and also water, is treated by means of the following steps:
a) cooling the fluid at the first temperature T1 to a second temperature T2 in a heat exchanger E,
b) drying the partially dried fluid at the second temperature T2 by passing through an adsorbent D to obtain a dried fluid,
c) separating the dried fluid by adsorption in a pretreatment unit P producing a fluid F1 depleted in carbon dioxide and a fluid F2 enriched in carbon dioxide.

The fluid F1 called the remainder is expanded in a turbine T and used to cool water in a tower by direct heat exchange. The expanded fluid is sent to the bottom of the tower W fed at the top with water to be cooled. Fluid depleted in carbon dioxide V leaves at the top of the tower W and the cooled water leaves at the bottom of the tower.

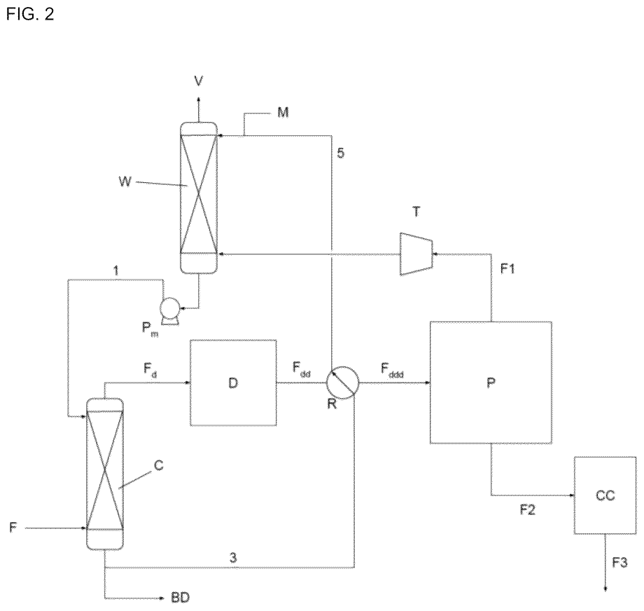

FIG. 2 shows a method for drying and purifying a fluid F at a first temperature T1 containing between 10 and 50 mol % carbon dioxide and also at least one impurity lighter than carbon dioxide chosen from the list: oxygen, nitrogen, argon, carbon monoxide, methane, helium and hydrogen, and also water. This fluid F may, for example, come from a cement works, from a lime production plant or from a steel production plant.

The fluid F is in the gaseous state and is cooled from a first temperature T1 to a second temperature T2 against water at a third temperature T3 lower than the first temperature T1 in a heat and matter exchange tower C by direct contact with the water 1 sent to the top of the tower, the fluid F arriving at the bottom of the tower. Water contained in the fluid F is cooled by contact with the water 1 to a temperature T2 lower than the first temperature T1 and consequently water contained in the fluid F condenses. The water 3 leaving the bottom of the tower at a fourth temperature T4 comprises condensed water contained in the fluid F.

The partially dried fluid F_{d} leaving at the top of the tower C at the second temperature T2, lower than the first temperature T1, still contains water and is dried in a dryer D by temperature swing adsorption to produce a dry fluid F_{dd} at a fifth temperature T5.

The dry fluid F_{dd} at the fifth temperature T5 is heated up in an indirect-contact heat exchanger R against water, for example at least part of the water flow 3, in order to obtain water 5 at a sixth temperature T6 and a dried fluid F_{ddd} at a seventh temperature T7 higher than the fifth temperature T5.

The water 5 cooled in heat exchanger R is cooled again by a cold-energy source and sent back to the top of the tower C. In this case, cooling takes place in a direct-contact tower W: the cold-energy source is a gas F1 expanded in a turbine T which cools the water 5 coming from the exchanger R in the direct heat exchange cooling tower W, producing a heated up gas V at the top of the tower W and the cooled water 1 at the bottom of the tower W.

The dry fluid F_{ddd} at the seventh temperature T7 is separated in a unit P by pressure swing adsorption and produces at least one gas F2 enriched in CO₂ and depleted in at least one other component, and one gas F1 enriched in the at least one other component and depleted in CO₂. The gas F1 is expanded in the turbine Cancelled optionally after having been heated up.

The gas F2 is compressed, cooled and separated by partial condensation and/or distillation and/or solidification in the separation unit CC forming a product F3 enriched in CO₂.

TABLE 1

| Temperature | Stream | Typical range (° C.) |
|---|---|---|
| T1 | Fluid F | [10-60] |
| T2 | Fluid F_{d} | [5-15] |
| T3 | Water 1 | [1-10] |
| T4 | Water 3 | [10-60] |
| T5 | Fluid F_{dd} | [10-20] |
| T6 | Water 5 | [10-40] |
| T7 | Fluid F_{ddd} | [20-60] |
| T8 | Cold-energy source | [−10-10] |

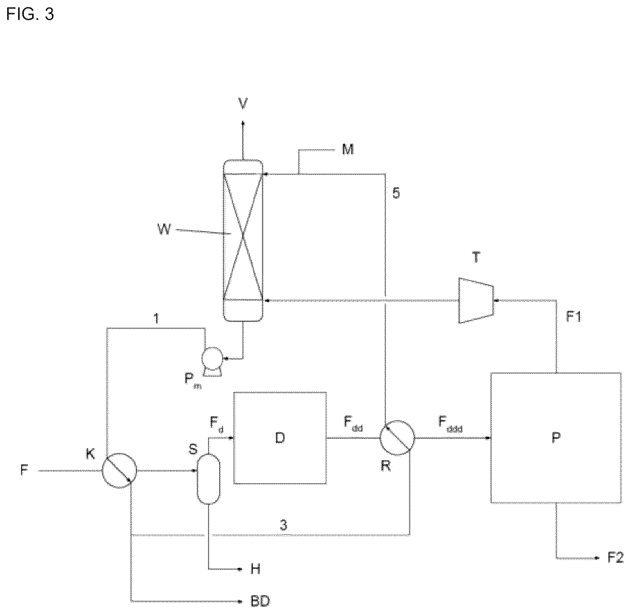

Unlike FIG. 2, FIG. 3 does not include the tower C. The fluid F is cooled by a cooler K by indirect heat exchange with the water 1 from the tower W. The fluid F is cooled therein to condense water contained therein, and the condensed water H is removed from a separator S which also produces the dried fluid F_{d}. The partially dried fluid F_{d} is dried in a dryer D. The water 1 having cooled the cooler K is sent at least partly as a flow 3 to the heat exchanger R in order to heat up the dried fluid F_{dd} downstream of the dryer D, and the cooled water 5 is sent back to the tower W in order to be cooled again to the temperature of the water 1.

Just as for FIG. 2, the dry fluid F_{ddd} at the seventh temperature T7 is separated in a unit P by pressure swing adsorption and produces at least one gas F2 enriched in CO₂ and depleted in at least one other component, and one gas F1 enriched in the at least one other component and depleted in CO₂. The gas F1 is expanded in the turbine T optionally after having been heated up.

The gas F2 is compressed, cooled and separated by partial condensation and/or distillation and/or solidification in the separation unit CC (not shown, see FIG. 2) forming a product F3 enriched in CO₂.

For both FIG. 2 and FIG. 3, the unit P can be a membrane separation unit.

For both FIG. 2 and FIG. 3, a part BD of the cooled water from the tower C or from the cooler K can be removed from the circulation to avoid the accumulation of elements contained in the fluid F, for example solid impurities, such as dust.

For both FIG. 2 and FIG. 3, water M can be added to the cycle to compensate for water losses, for example water leaving the apparatus in the gas V.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for drying and purifying a fluid at a first temperature containing between 10 and 50 mol % of carbon dioxide and also at least one impurity lighter than carbon dioxide chosen from the list: oxygen, nitrogen, argon, carbon monoxide, methane, helium and hydrogen, and also water, comprising:
a) cooling the fluid at the first temperature to a second temperature against water at a third temperature lower than the first temperature and partially condensing the water contained in the fluid, the cooling water heating up to a fourth temperature,
b) separating the condensed water to obtain a partially dried fluid at the second temperature,
c) drying the partially dried fluid at the second temperature by passing through an adsorbent to obtain a dried fluid at a fifth temperature,
d) heating up the dried fluid at the fifth temperature against water which cools to obtain water at a sixth temperature and a dried fluid at a seventh temperature,
e) cooling the water at the sixth temperature by heat exchange with a cold-energy source at an eighth temperature colder than the sixth temperature, generating water at the third temperature, and
f) using the water generated at the third temperature during step e) to cool the fluid at the first temperature during step a).

2. The method according to claim 1, in which the dried fluid at the seventh temperature is separated into a first fraction at a ninth temperature which is more concentrated in CO₂ than the dried fluid at the seventh temperature, and a second fraction at a tenth temperature which is less concentrated in CO₂ than the dried fluid at the seventh temperature.

3. The method according to claim 2, in which the second fraction at the tenth temperature is expanded after heating, thereby generating a second fraction at the eighth temperature used as a cold-energy source in step e).

4. The method according to claim 1, in which the cooling in step e) is achieved by direct-contact heat exchange between the water at the sixth temperature and the cold-energy source.

5. The method according to claim 1, in which the cooling in step e) is achieved by indirect-contact heat exchange between the water at the sixth temperature and the cold-energy source.

6. The method according to claim 1, in which the cooling in step a) is achieved by direct-contact heat exchange between the fluid at the first temperature and the water at the third temperature.

7. The method according to claim 1, in which the cooling in step a) is achieved by indirect-contact heat exchange between the fluid at the first temperature and the water at the third temperature.

8. The method according to claim 2, in which the separation of the dried fluid at the seventh temperature is carried out by means of a pressure swing adsorption system.

9. The method according to claim 2, in which the separation of the dried fluid at the seventh temperature is carried out by means of a membrane system.

10. The method according to claim 8, in which the first fraction at the ninth temperature which is more concentrated in CO₂ than the dried fluid at a seventh temperature is compressed and then purified by partial condensation and/or distillation and/or solidification in order to produce a third fraction which is more concentrated in CO₂ than the first fraction.

11. The method according to claim 1, in which the water which cools in step d) comprises at least part of the water which heats up in step a).
